(19) United States
(12) Patent Application Publication
(10) Pub. No.: US 2015/0125235 A1
(43) Pub. Date: May 7, 2015

(54) Attachment device and method for attaching elements

(71) Applicant: Airbus Operations GmbH, Hamburg (DE)

(72) Inventors: Hermann Benthien, Hamburg (DE); Andreas Poppe, Hamburg (DE)

(21) Appl. No.: 14/530,041

(22) Filed: Oct. 31, 2014

(30) Foreign Application Priority Data
Nov. 5, 2013 (DE) 10 2013 222 444.3

(51) Int. Cl. F16B 21/12; F16B 21/06

(52) U.S. Cl. CPC F16B 21/12; F16B 21/065
USPC 411/72

(57) ABSTRACT

An attachment device for attaching at least one element, in particular lines such as cables, pipes, hoses and the like, to a component section. The attachment device comprises a retaining section for encompassing, at least in some sections, at least one such element, and comprising a flange section for resting against the component section. Spring sections of a hollow engagement body, which spring sections are acting in the radial direction, are blocked as a result of the insertion of a securing pin into the interior of the engagement body, and can thus no longer be moved radially inwards towards each other. A method for installing such an attachment device.

### CROSS-REFERENCES TO RELATED APPLICATIONS

This application claims the benefit of the German patent application No. 10 2013 222 444.3 filed on Nov. 5, 2014, the entire disclosures of which are incorporated herein by way of reference.

### BACKGROUND OF THE INVENTION

The invention relates to an attachment device for attaching at least one element to a component section, in particular lines such as cables, pipes, hoses and the like, and to a method for attaching such elements by means of such an attachment device.

Modern vehicles such as aircraft and spacecraft comprise a multitude of lines such as cables for the transmission of electricity, data or signals, air conditioning pipes, freshwater pipes, wastewater pipes and the like. Attachment of the lines frequently takes place on the primary structure by means of corresponding attachment devices. A known attachment device for attaching cables comprises a retaining section for encompassing the cable and a flange section that comprises a hole for accommodating a screw. In the installed state the screw interacts with a plate nut arranged on an insert that, by way of rivets, is non-rotationally attached to the rear of the component section. Usually a washer is arranged underneath the front screw head or between the screw head and the flange section. Thus at least four elements are required to attach the cable to the component section, namely a screw, a plate nut, an insert for retaining the plate nut, and a washer.

Alternative attachment devices provide for cutting or turning a flange section into the respective component section. Further known attachment devices are, for example, shown in DE 10 2006 053 966 A1 and DE 10 2009 022 175 A1.

### SUMMARY OF THE INVENTION

It is an object of the invention to create an attachment device that allows simple and quick installation and that is of lightweight construction. Furthermore, it is an object of the invention to create a method that allows simple and quick installation.

An attachment device according to the invention for attaching at least one element, in particular lines such as cables, pipes, hoses and the like, to a component section comprises a retaining section for encompassing, at least in some sections, the at least one element, and comprises a flange section for resting against the component section. The flange section comprises a hole. According to the invention, the attachment device comprises a hollow engagement body that can be inserted into the hole or that forms the hole, wherein the engagement body comprises spring sections that relative to the longitudinal axis of the engagement body comprise engagement projections, arranged on the outside, for positive-locking engagement with the component section. Furthermore, according to the invention, the attachment device comprises a securing pin that can be inserted into the engagement body for securing its engagement position.

Because of its spring sections, the engagement body comprises radial elasticity that makes possible the installation and that in the installed state is blocked by the securing pin so that the engagement body is positionally secured. When compared to the known attachment device described above, at most two components are required for fastening the element to a component section rather than at least four elements; namely the engagement body and the securing pin. If the engagement body is designed so as to be an integral part of the flange section, only one component is required for fastening the element, namely the securing pin. As a result of the reduced number of components, the assembly is simplified and shortened, and in addition the weight of the attachment device according to the invention is reduced. Furthermore, the installation is simplified and shortened in that the attachment device according to the invention is based on having positive fit so that in addition there is no need to use expensive and heavy riveting machines. Consequently, the weight of the attachment device can be further reduced in that said device comprises a plastic material or a corresponding composition of plastic materials. Furthermore, any materials incompatibilities with the component section, for example contact corrosion, can thus be prevented. Moreover, the elastic properties of the spring sections can be set by a corresponding selection of the plastic material.

Preferably, the spring sections are evenly distributed over the circumference of the engagement body. This prevents any canting of the engagement body during installation. The engagement body is self-aligning during installation.

In an exemplary embodiment the engagement body comprises at least two spring sections of equal size, which spring sections preferably in each case are spaced apart or separated from the adjacent spring sections by way of an axial slot, thus forming an axially-slotted spring washer. For example, if the engagement body comprises four spring sections, very low installation force can be achieved because none of the spring sections extends over an angle greater than 90° relative to the circumference of the engagement body. Of course, some other division, for example into three or five spring sections, can also take place.

In order to prevent any radial movement of the engagement body in the installed state, said engagement body can comprise an external contour that approximately corresponds to an internal contour of the hole in the flange section and/or to a component hole through which the engagement body can be guided at least in some sections.

In order to compensate, for example, for thickness tolerances of the flange section and/or of the component section in the region of its hole, it is advantageous if the attachment device comprises at least one spring element for axially preloading the engagement body. The spring element can be integrated in the engagement body or can be designed as an individual element. Furthermore, by means of preloading, the flange section and the component section are permanently pressed against each other so that any loosening of the contact between the flange section and the component section is effectively counteracted.

In order to prevent radial deformation or compression of the engagement body in the installed state it is advantageous if a body section of the securing pin can be made to contact, over the entire circumference or almost over the entire circumference, the spring sections. In the installed state the spring sections of the engagement body rest radially against the body section of the securing pin and can thus not be compressed or radially moved inwards.

In order to prevent the securing pin from falling out of the engagement body in the inserted state, the securing pin can comprise at least one locking section that is arranged radially on the outside relative to its longitudinal axis, and the engagement body can comprise at least one corresponding retention section that is arranged radially on the inside. Preferably, the locking section forms a partial region of the body section that in the installed state is encompassed by the spring sections. In this manner the insertion of the securing pin into the engagement body can be simplified because the spring sections, because of their radial elasticity, can yield radially outwards during the insertion of the securing pin. In an exemplary embodiment the locking section is a spherical ring shoulder so that both simplified installation and non-destructive de-installation of the securing pin is possible.

In order to prevent rotation of the attachment device in the installed state relative to the component section, the attachment device can comprise a, in particular plate-shaped or disc-shaped, packing element for arrangement between the component section and the flange section, with the friction coefficients of said packing element exceeding a respective friction coefficient of the flange section and of the component section. By means of the packing element, during installation of the attachment device a friction ratio between the flange section and the component section is automatically set, which friction ratio prevents any rotation of the flange section relative to the component section. It is thus possible to do without any additional attachment means such as rivets or end stops as anti-rotation devices, which has a positive effect on the installation time and on the weight of the attachment device. As far as its material or its materials composition and its friction ratios are concerned, the packing element can be matched to the flange section and to the component section so that there is no need for the flange section and/or the component section themselves to be separately surface-treated, for example roughened. In particular with interaction with the spring head, in such a manner a very reliable and individual anti-rotation device can be set.

As an alternative or in addition to the packing element, as an anti-rotation device or for the transmission of torsional forces, the engagement body and at least the component hole that accommodates the engagement body in some sections can be of a corresponding non-circular design.

In a method according to the invention for attaching at least one element, in particular lines such as cables, pipes, hoses and the like, to a component section, in particular by means of an attachment device according to the invention, an attachment device comprising a hole is aligned so as to be flush with a hole in the component section, and a hollow engagement body with engagement projections is inserted into the holes. As an alternative, on the side of the attachment device, a hollow engagement body with engagement projections is inserted into a hole of the component section. After insertion of the engagement body the latter is locked to the component in both variants. Subsequently a securing pin is inserted into the engagement body in order to secure its engaged position.

The method according to the invention allows simple and quick installation of the attachment device, because on the one hand few components need to be handled, and on the other hand the attachment device exclusively acts on the basis of positive fit so that there is no need to provide expensive screwing, riveting or bonding work. The securing pin prevents radial compression of the installed engagement body so that reliable attachment is achieved. In particular, the positive-locking connection furthermore makes possible one-sided installation of the attachment device because locking takes place automatically. There is no need to provide rear access to the engagement projections. Installation of the attachment device can quasi take place in a blind manner.

Preferably a flange section, which comprises a hole, of the attachment device is non-rotationally held to the component section by means of friction. In this way it is not necessary to provide anti-rotation devices such as additional attachment devices and/or limit stops that would otherwise be necessary.

If the component hole comprises radially-inward-pointing sections, the engagement projections of the engagement body can also be designed as engagement depressions or as an engagement groove. The term “engagement projections” thus also includes engagement depressions.

### BRIEF DESCRIPTION OF THE DRAWINGS

Below, preferred exemplary embodiments of the invention are shown in more detail with reference to greatly simplified diagrams as follows:

FIG. 1 is a diagram of a first exemplary embodiment of an attachment device according to the invention,

FIG. 2 is a vertical section of the attachment device of FIG. 1 in the installed state,

FIG. 3 is a vertical section of a second exemplary embodiment of the attachment device according to the invention in the installed state,

FIG. 4 is a vertical section of the attachment device of FIG. 3 without the securing pin,

FIG. 5 is an individual view of the securing pin of the attachment device of FIG. 3,

FIG. 6 is the attachment device of FIG. 3 in the installed state with a packing element as an anti-rotation device, and

FIG. 7 is a vertical section of a third exemplary embodiment of the attachment device according to the invention in the installed state with a packing element as an anti-rotation device.

### DETAILED DESCRIPTION OF THE PREFERRED EMBODIMENTS

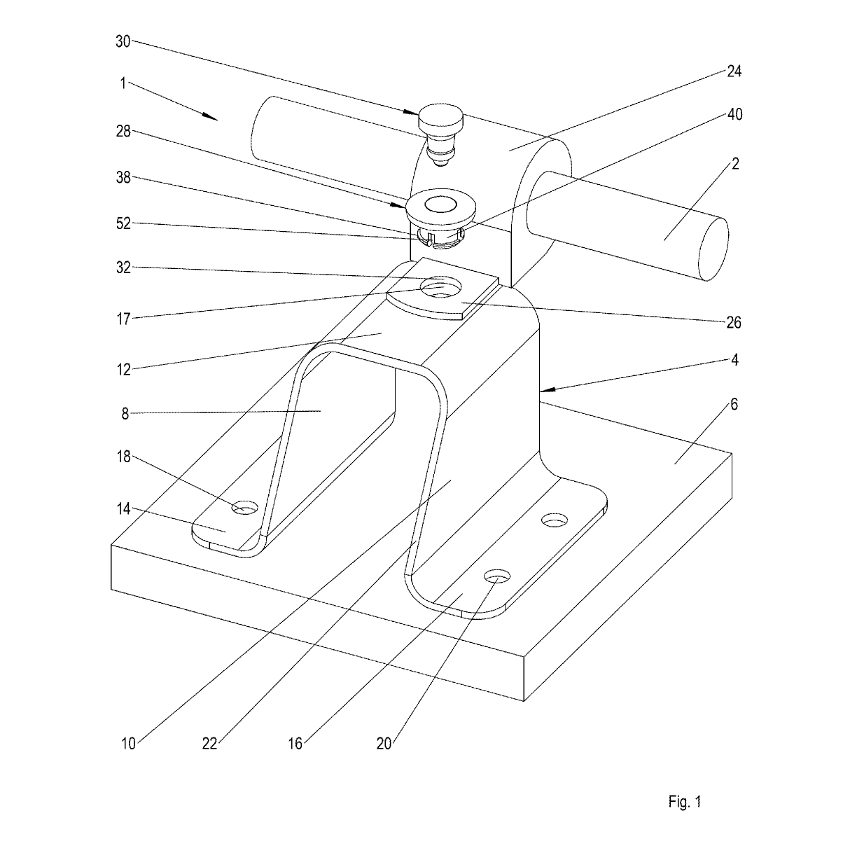

FIG. 1 shows a diagram of a first exemplary embodiment of an attachment device 1 according to the invention for attaching an element 2, in particular a line such as a cable and/or a bundle of cables, to a section of a component 4. The component 4 in turn can, for example, be attached to a structure 6 so that, as is the case in the exemplary embodiment presently shown, the component 4 acts as a kind of adaptor for arranging the element 2 on the structure 6. The use of the component 4 as an adapter is known, for example, in aircraft or spacecraft engineering in cases where the element 2 is to be attached to a primary structure of an aircraft or spacecraft and where so-called open holes in the primary structure are not permissible according to the relevant regulations. In the absence of such regulations the attachment device 1 can also be attached directly to the structure 6, and in this case the component 4 can represent the primary structure that actually accommodates the element.

In the present diagram the component 4 comprises, for example, an omega-shaped or an A-shaped profile with two side walls 8, 10 that extend parallel to each other, which side walls 8, 10 are interconnected by way of a planar head wall 12 that extends orthogonally to said side walls 8, 10 and in each case comprise an outwards-pointing base section 14, 16 for attachment to the structure 6. In order to fasten the attachment device 1, the head wall 12 comprises a hole or component hole 17 through which a hollow engagement body 28 of the attachment device 1 can be fed in some sections. For the purpose of accommodating attachment means such as rivets, each base section 14, 16 comprises corresponding holes 18, 20. For weight reduction, one face 22 of the base body 4 is beveled in such a manner that the head wall 12 is shortened relative to the base sections 14, 16.

The attachment device 1 preferably comprises a plastic material or a composition of plastic materials. In this manner, on the one hand any problems relating to corrosion of the component 4 are prevented irrespective of its material, and on the other hand reduced weight of the attachment device 1 is achieved. The attachment device 1 comprises a retaining section 24 for encompassing the element 2 at least in some sections, a flange section 26 for arrangement on the component 4 or on its head wall 12, the above-mentioned hollow engagement body 28 for locking the attachment device 1 to the component 4, and a securing pin 30 for securing the engagement body 28 in its engaged position.

The flange section 26 comprises a plate-shaped design and comprises a hole or flange hole 32 for inserting the engagement body 28. In the engaged state the flange hole 32 is oriented so as to be flush with the component hole 17. Preferably, the internal diameter of the component hole 17 and of the flange hole 32 is identical.

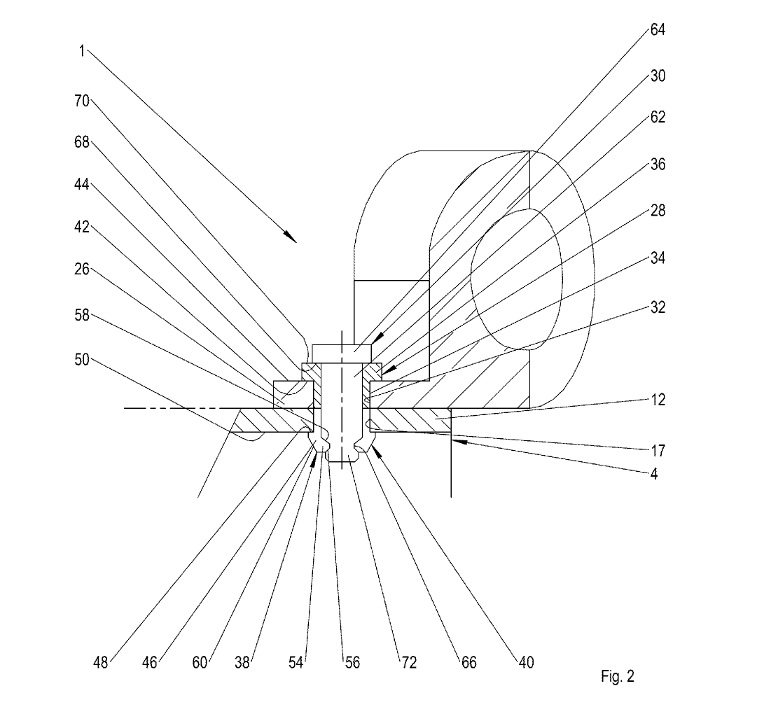

In this exemplary embodiment, as shown in FIG. 2, the engagement body 28 is tubular and comprises a cylindrical shaft 34 or cylindrical section with an internal contour that has a constant internal diameter, and an external contour that has a constant external diameter. The cylindrical shaft 34 external contour approximately corresponds to the internal contour of the holes 17, 32. The shaft 34 extends between an annular head limit stop 36 and a multitude of spring sections 38, 40 on the side of the base.

The head limit stop 36 extends orthogonally to the longitudinal axis of the engagement body 28 and in the installed state of the attachment device 1, the lower surface 42 of said head limit stop 36 rests flat against the top surface 44 of the flange section 26.

The spring sections 38, 40 act in the radial direction relative to the longitudinal axis of the engagement body 28, and in each case for the purpose of locking to the base body 4 comprise a radially-outwards-pointing engagement projection 46 with an engagement surface 48 which in the present diagram extends orthogonally to the longitudinal axis of the engagement body. For the sake of clarity only the left-hand spring section 38 in FIG. 2 is shown with a detailed reference number, representative of all the spring sections 38, 40. In the installed state the engagement surfaces 48 of the engagement body 28 rest flat against a bottom surface 50 of the component 4, which bottom surface 50 comprises the component hole 17 so that in interaction with its head limit stop 36, which rests against the top surface 44 of the flange section 26, the retaining section 24 is locked to the component 4 in the axial direction. In the exemplary embodiment shown, four spring sections 38, 40 of equal size are provided that together form a spring washer and in each case encompass a circumferential angle of approx. 90°. In its locked base position, which in the diagram shown is locked and preferably free of any deformation, the spring washer comprises an internal diameter and an external diameter identical to those of the cylindrical section 34. The respective adjacent spring sections 38, 40 are separated by way of axial slots 52 provided on the base (see FIG. 1) so that the spring washer comprises slots in the axial direction.

For locking to the securing pin 30, each of the spring sections 38, 40 has a radially-inwards-projecting retention section 54, which in interaction with its adjacent retention sections 54 results in a securing ring. The securing ring 30 has a ring surface 56 that faces the installation direction, and an opposed ring surface 58 which faces the de-installation direction, which ring surfaces are interrupted by the axial slots 52, and which ring surfaces in this exemplary embodiment are approximately identically positioned in relation to their respective directions.

For ease of installation, or for ease of inserting the engagement body 28 into the holes 17, 32, the base of the engagement body 28 comprises a conical taper in the direction of installation. In order to form the conical taper, each of the spring sections 38, 40 comprises correspondingly designed inclined planes 60 on the external circumference.

In the present diagram the securing pin 30 comprises a full cross section with a shaft 62 that extends between a radially enlarged head 64 and a locking section 66 on the base.

The shaft 62 essentially comprises a cylindrical external diameter that corresponds to the internal diameter of the engagement body shaft 34 and of the spring washer formed by the spring sections 38, 40 so that the shaft 62 of the securing pin 30 is encompassed on its entire circumference by the spring washer, and thus with the securing pin 30 inserted the engagement body 28, is fixed in the radial direction in the holes 17, 32 because the radial elasticity of the spring sections 38, 40 is blocked.

In the present diagram the head 64 is designed as a plate head and extends orthogonally to the longitudinal axis of the securing pin 30. Said head 64 comprises an annular lower surface 68 by means of which the securing pin 30 in the installed state rests flat against an annular upper surface 70 of the head limit stop 36 on the side of the engagement body.

In the exemplary embodiment presently shown, the locking section 66 for securing the securing pin 30 in the engagement body 28 in axial direction is designed as a circumferential groove which in the locked state the securing ring or the retention sections 54 engage with positive fit. The circumferential groove thus comprises groove walls (not shown with reference characters) that correspond to the ring surfaces 56, 58 of the securing ring.

For easier installation of the securing pin 30, the shaft 62 comprises a free end section 72, which in the direction of installation is positioned in front of the locking section 66, which end section 72 comprises a reduced cross section when compared to the cross section of the shaft 62, with the end section 72 being beveled in the direction of installation.

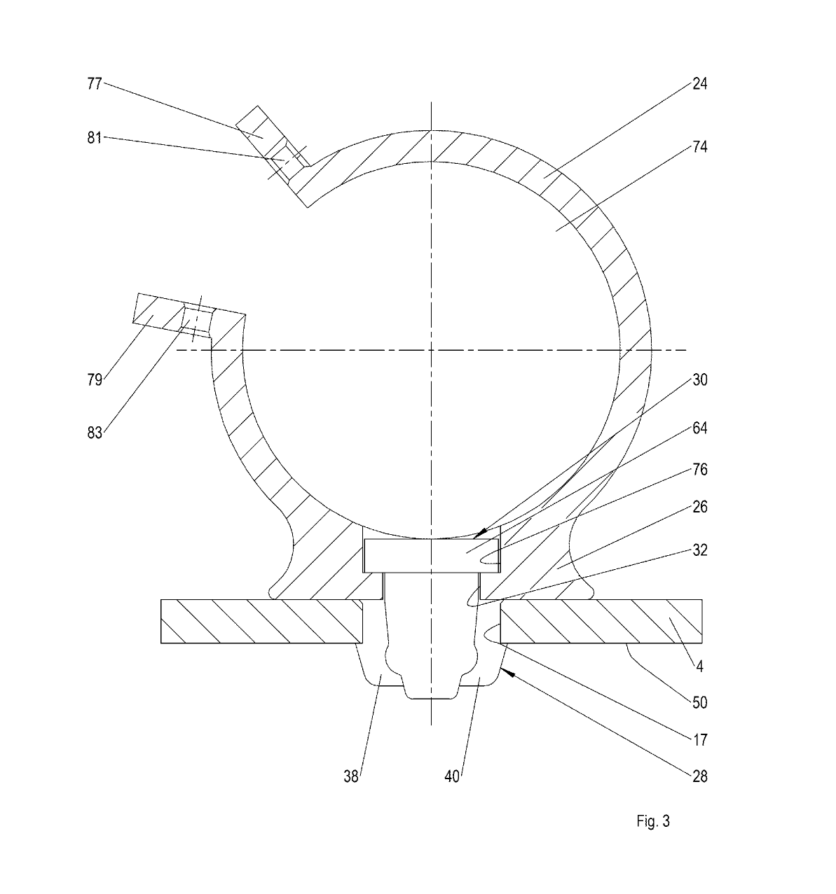

FIG. 3 shows an exemplary embodiment of the attachment device 1 according to the invention in which the engagement body 28 is designed in a single piece or integrally with the flange section 26. The engagement body 28 is thus not a device element that has been produced separately of the flange section 26 or that can be separated from the flange section 26. The engagement body 28 quasi is a tubular projection with corresponding spring sections 38, 40, which tubular projection comprises a flange hole 32. The flange section 26 in turn forms an integral part of a retaining section 24 and is integrated in such a manner in said retaining section 24 that the engagement body 28 or the flange hole 32 extends radially to the retaining section 24 and is arranged in the center relative to the aforesaid so that no moments, or almost no moments, are introduced into the engagement body 28 by the respectively accommodated element. According to the first exemplary embodiment, the attachment device 1 and in particular the engagement body 28 are plastics-based.

In order to prevent, in the installed state, a reduction in the cross section by a head 64 of a securing pin 30, which head projects into an accommodation space 74 for the respective element of the retaining section 24, on the side of the accommodation space 74, the flange hole 32 has been radially enlarged relative to its longitudinal axis in such a manner that a depression 76 is formed for countersinking the head 64. For circumferentially closing the accommodation space 74 the retaining section 24 comprises, for example, two closure sections 77, 79 that extend radially outwards, which closure sections 77, 79 in each case comprise a breakthrough 81, 83 for the feed-through of a closure means, for example a cable tie.

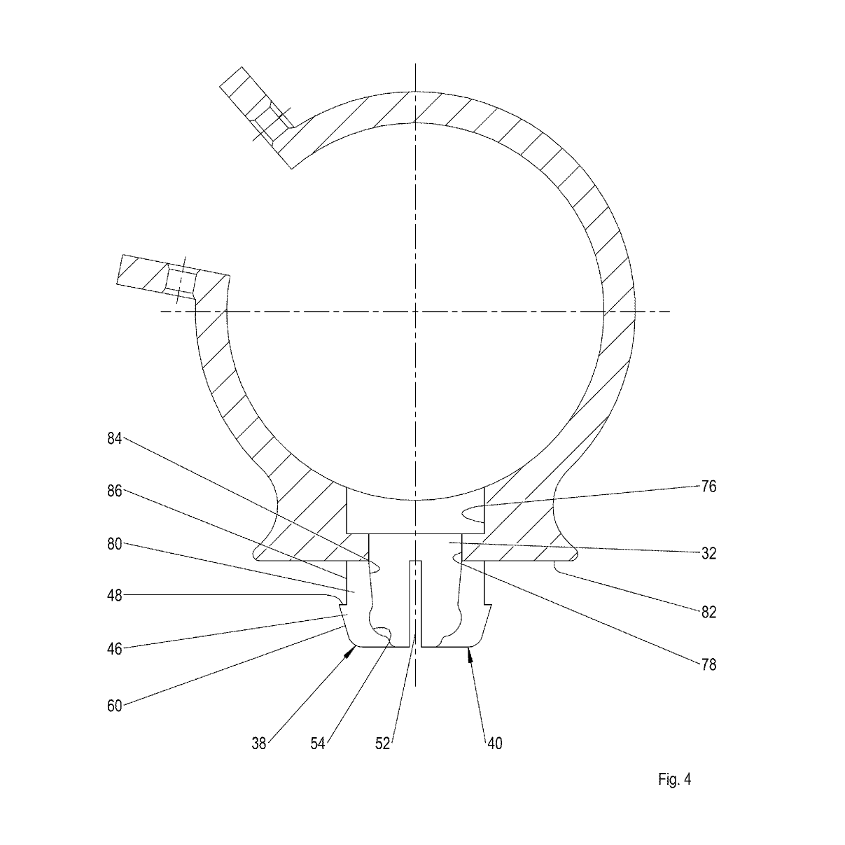

As shown in FIG. 4, starting from the depression 76, the flange hole 32 comprises a cylindrical internal circumferential wall 78 of a constant internal diameter. The internal circumferential section 78 makes a transition to the spring sections 38, 40. According to the first exemplary embodiment, the spring sections 38, 40 are designed as four circumferential segments of equal size, with each of the segments being separated from each other by an axial slot 52 and forming an axially slotted spring washer. In each case a body section 80 of the spring sections 38, 40 extends perpendicularly from a contact surface 82 of the flange section 26, which contact surface 82 faces the component 4, and as a spring washer forms an internal circumferential wall 84 that conically tapers off in the direction of installation, and a cylindrical external circumferential wall 86. For the sake of clarity, only the left-hand spring section 38 in FIG. 4 is shown with a detailed reference number, representative of all the spring sections 38, 40. Preferably, the external diameter of the external circumferential wall 86 corresponds to the internal diameter of a component hole 17 shown in FIG. 3.

In each case the body sections 80 make a transition to an engagement projection 46 and to a retention section 54. According to the first exemplary embodiment the engagement projections 46 comprise an engagement surface 48, which extends orthogonally to the longitudinal axis of the engagement body, for resting against a bottom surface 50, shown in FIG. 3, of the component 4 and an inclined plane 60 on the side of the external circumference, for easier insertion into the component hole 17. In this embodiment the retention sections 54 form a concave circumferential groove.

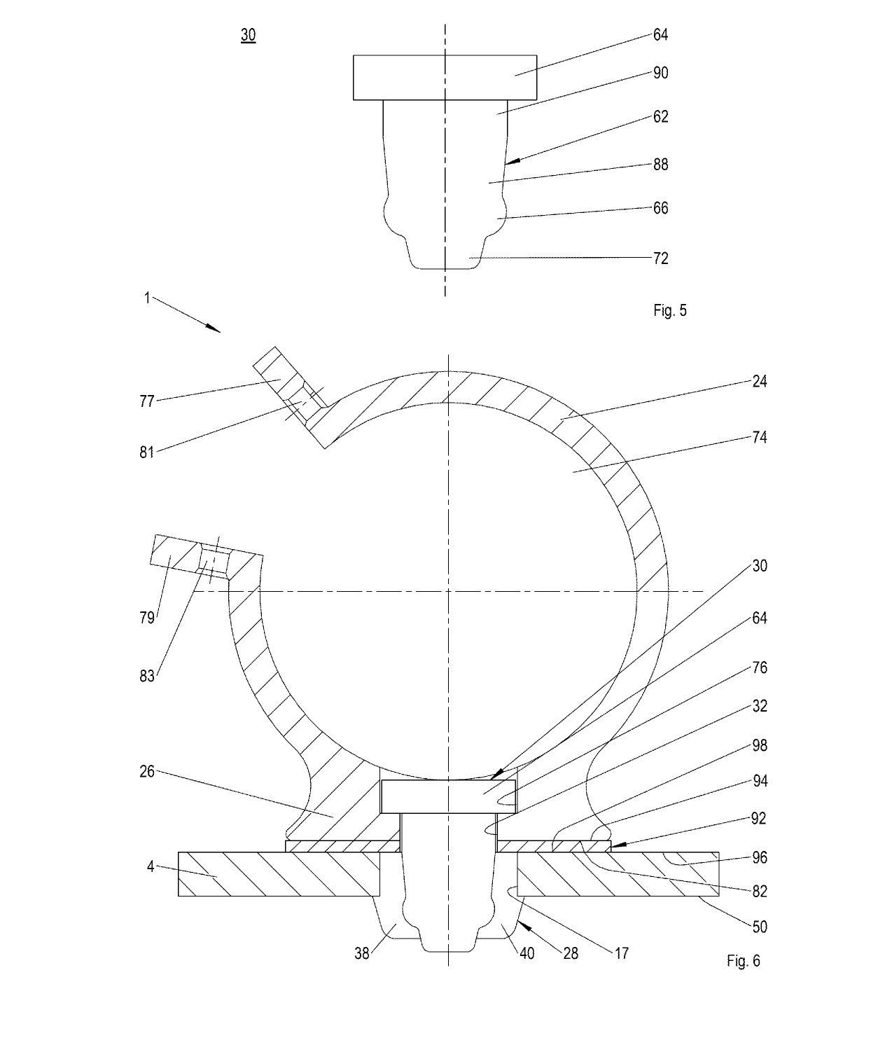

As shown in FIG. 5, the securing pin 30 comprises a shaft 62 with a full cross section. As an essential difference to the securing pin 30 according to the first exemplary embodiment, the shaft 62 comprises a conical section 88 and a spherical locking section 66 on the base. The conical section 88 extends from a cylindrical section 90 on the head section and makes a transition to the spherical locking section 66. The cylindrical section 90 preferably comprises an external diameter that is somewhat smaller than an internal diameter defined by the body sections 80 of the spring sections 38, 40. The conical section 88 preferably comprises a cone angle that is identical to the cone angle of the spring washer so that in combination with the smaller external diameter of the cylindrical section 88 relative to the internal diameter of the body sections 80 of the spring sections 38, 40 self-centering of the securing pin 30 in the engagement body 28 takes place. A head 64 of the securing pin 30, which head 64 in the present embodiment is plate-shaped, has an external diameter that is somewhat smaller than the internal diameter of the depression 76. For ease of insertion into the flange hole 32, a free end section 72 of the securing pin 30 is conically tapered in the direction of installation.

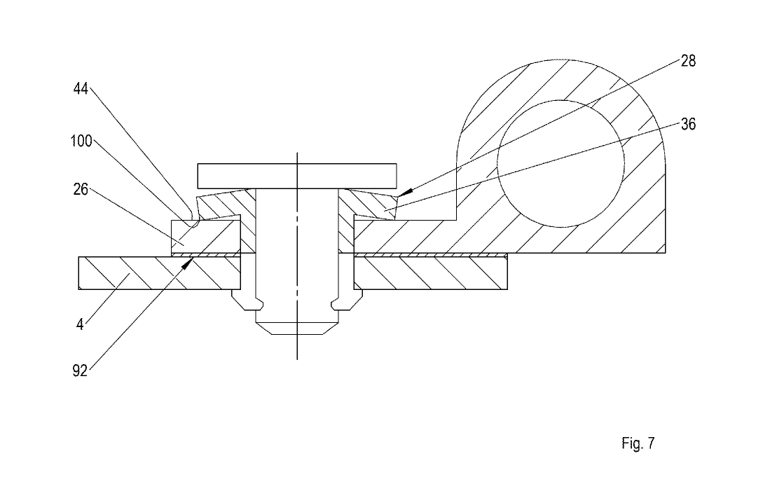

In order to prevent rotation of the retaining section 24 relative to the component 4 with minimum installation force, as shown in FIG. 6, the attachment device 1 can comprise a plate-shaped or flat packing element 92 that in the installed state is arranged between the flange section 26 and the component 4. On its opposite friction surfaces 94, 96 the packing element 92 has a friction coefficient that is greater than the friction coefficient of the flange section 26 at its contact surface 82 facing the friction surface 94, and greater than a friction coefficient of the component 4 or the latter's head wall 12 at its contact surface 98 facing the friction surface 96. Preferably, the packing element 92 comprises a plastic material or a corresponding composition of plastic materials. In order to reduce the introduction of vibrations from the component 4 to the retaining section 24 and thus into the retained element the packing element 92 can, furthermore, comprise elastic or damping characteristics.

FIG. 7 shows an exemplary embodiment based on the first exemplary embodiment in which a head limit stop 36 of the engagement body 28 is designed as a spring head that acts in the axial direction. In this way it is possible, on the one hand, to compensate for thickness tolerances of the flange section 26 in the region of its hole 32 and/or of the component 4 in the region of its hole 17, and on the other hand, the flange section 26 and the component 4 can be pressed towards each other at a preload force. Furthermore, as a result of preloading, a respective friction coefficient between a packing element 92 and the flange section 26 and the component 4 can be set.

In the exemplary embodiment shown in FIG. 7, the spring action is achieved by positioning the head limit stop 36. In this arrangement said head limit stop 36 is positioned in the longitudinal direction of a longitudinal axis of the engagement body in such a manner that only the radially outermost lower-surface edge 100 of the head limit stop 36 rests against the flange section 26, with said head limit stop 36 otherwise being spaced apart from a top surface 44 of the flange section 26. Of course, the head limit stop 36 can also be designed as shown in the first exemplary embodiment according to FIGS. 1 and 3, with a spring element such as a spiral spring or plate spring being arranged underneath it. Furthermore, it is of course also possible to provide a spring element in the second exemplary embodiment according to FIGS. 3 to 6. To this effect the flange section 26 of the second exemplary embodiment would have to comprise an accommodation chamber for arrangement of the spring element in the region of its contact surface 82 that preferably encompasses the flange hole 32.

In a method according to the invention for attaching an element 2 to a component 4 by means of the attachment device 1, according to the first and third exemplary embodiments according to FIGS. 1, 2 and 7, the attachment device 1 is positioned so that its flange hole 32 is aligned with the component hole 17. Subsequently the hollow engagement body 28 with its engagement projections 46 is inserted into the aligned holes 17, 32 and is locked to the component 4. During insertion the spring sections 38, 40 are moved radially inwards, and during locking they are moved radially outwards, preferably back to their deformation-free base position. Subsequently the securing pin 30 is inserted into the engagement body 28 for securing its engagement position. At least in some sections the securing pin 30 rests over the entire circumference against the spring washer, thus preventing radial inwards movement of the spring sections 38, 40 so that locking to the component 4 cannot be undone. Furthermore, the securing pin 30 with its locking section 66 establishes effective engagement with the retention section 54 of the engagement body 28 and is thus positionally fixed in the axial direction.

In an attachment device 1 according to the second exemplary embodiment according to FIGS. 3 to 6 the hollow engagement body 28 is inserted into the component hole 17. The engagement body 28 is locked to the component 4 and subsequently the securing pin 30 is inserted into the engagement body 28 for securing said engagement body 28 in its locked position.

If the packing element 92 is arranged between the component 4 and the flange section 26, as shown in FIGS. 3 to 6, said packing element 92 is preferably slid onto the engagement body 28, preferably prior to the insertion of the engagement body 28 into the component hole 17.

Disclosed is an attachment device for attaching at least one element, in particular lines such as cables, pipes, hoses and the like, to a component section comprising a retaining section for encompassing, at least in some sections, at least one such element, and comprising a flange section for resting against the component section, wherein spring sections of a hollow engagement body, which spring sections act in the radial direction, are blocked as a result of the insertion of a securing pin into the interior of the engagement body and can thus no longer be moved radially inwards towards each other, and a method for installing such an attachment device.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE CHARACTERS

1 Attachment device
2 Element
4 Component section
6 Primary structure
8 Side wall
10 Side wall
12 Head wall
14 Base section
16 Base section
17 Hole/component hole
18 Hole
20 Hole
22 Front face
24 Retaining section
26 Flange section
28 Engagement body
30 Securing pin
32 Hole/flange hole
34 Shaft/cylindrical section
36 Head limit stop
38 Spring section
40 Spring section
42 Lower surface
44 Top surface
46 Engagement projection
48 Engagement surface
50 Bottom surface
52 Axial slot
54 Retention section
56 Ring surface
58 Ring surface
60 Inclined plane
62 Shaft
64 Head
66 Locking section
68 Lower surface
70 Upper surface
72 End section
74 Accommodation space
76 Depression
77 Closure section
78 Internal circumferential wall
79 Closure section
80 Body section
81 Breakthrough
82 Contact surface
83 Breakthrough
84 Internal circumferential wall
86 External circumferential wall
88 Conical section
90 Cylindrical section
92 Packing element
94 Friction surface
96 Friction surface
98 Contact surface
100 Lower-surface edge

1. An attachment device for attaching at least one element to a section of a component, comprising:
a retaining section configured to encompass, at least in some sections, the at least one element,
a flange section configured to rest against the component section and which comprises a hole,
a hollow engagement body configured to be either insertable into the hole or forming the hole,
the engagement body comprising spring sections that, relative to a longitudinal axis of the engagement body, comprise engagement projections, arranged on the outside, for positive-locking engagement with the component section, and
a securing pin configured to be insertable into the engagement body for securing its engagement position.

2. The attachment device of claim 1, wherein the spring sections are evenly distributed over a circumference of the engagement body.

3. The attachment device of claim 1, wherein the engagement body comprises at least two spring sections of equal size.

4. The attachment device of claim 1, wherein the engagement body comprises an external contour that approximately corresponds to an internal contour of at least one of the hole in the flange section and a component hole through which the engagement body can be guided at least in some sections.

5. The attachment device of claim 1, further comprising at least one spring element for axially preloading the engagement body.

6. The attachment device of claim 1, wherein a body section of the securing pin is configured to contact, over at least most of an entire circumference, the spring sections.

7. The attachment device of claim 1, wherein the securing pin comprises at least one locking section that is arranged radially on the outside relative to its longitudinal axis, and the engagement body comprises at least one corresponding retention section that is arranged radially on the inside of the engagement body.

8. The attachment device of claim 1, further comprising a packing element for arrangement between the component section and the flange section, with friction coefficients of said packing element exceeding a respective friction coefficient of the flange section and of the component section.

9. The attachment device of claim 1, wherein the engagement body and at least the component hole that accommodates the engagement body in some sections are of a corresponding non-circular design.

10. The attachment device of claim 1, wherein the at least one element comprises at least one of a cable, a pipe and a hose.

11. A method for attaching at least one element to a component section, by means of an attachment device for attaching at least one element to a section of a component, comprising:
a retaining section configured to encompass, at least in some sections, the at least one element,
a flange section configured to rest against the component section and which comprises a hole,
a hollow engagement body configured to be either insertable into the hole or forming the hole,
the engagement body comprising spring sections that, relative to a longitudinal axis of the engagement body, comprise engagement projections, arranged on the outside, for positive-locking engagement with the component section, and
a securing pin configured to be insertable into the engagement body for securing its engagement position, comprising the steps of:
a) either aligning an attachment device comprising a hole so that it is flush with a hole in the component section, and inserting a hollow engagement body with engagement projections into the holes, or
b) inserting a hollow engagement body, on the side of the attachment device, with engagement projections, into a hole of the component section, wherein
c) both in a) and in b), after insertion of the hollow body, locking the engagement body to the component section, and inserting a securing pin into the engagement body in order to secure an engaged position of the engagement body relative to the component section.

11. The method of claim 9, further including non-rotationally holding a flange section, which comprises the hole of the attachment device, to the component section by means of friction.
